(19) United States
(12) Patent Application Publication
(10) Pub. No.: US 2012/0299837 A1
(43) Pub. Date: Nov. 29, 2012

(54) IDENTIFYING CONTACTS AND CONTACT ATTRIBUTES IN TOUCH SENSOR DATA USING SPATIAL AND TEMPORAL FEATURES

(75) Inventors: Hrvoje Benko, Seattle, WA (US); John Miller, Redmond, WA (US); Shahram Izadi, Cambridge (GB); Andy Wilson, Seattle, WA (US); Peter Ansell, Watford (GB); Steve Hodges, Cambridge (GB)

(73) Assignee: MICROSOFT CORPORATION, Redmond, WA (US)

(21) Appl. No.: 13/114,060

(22) Filed: May 24, 2011

(51) Int. Cl. G06F 3/041

(52) U.S. Cl. 345/173

(57) ABSTRACT

A touch sensor provides frames of touch sensor data, as the touch sensor is sampled over time. Spatial and temporal features of the touch sensor data from a plurality of frames, and contacts and attributes of the contacts in previous frames, are processed to identify contacts and attributes of the contacts in a current frame. Attributes of the contacts can include, whether the contact is reliable, shrinking, moving, or related to a fingertip touch. The characteristics of contacts can include information about the shape and rate of change of the contact, including but not limited to a sum of its pixels, its shape, size and orientation, motion, average intensities and aspect ratio.

### BACKGROUND

A class of computer input devices, called multi-touch devices, includes devices that have a touch sensor that can sense contact at more than one location on the sensor. A user touches the device on the touch sensor to provide touch input, and can make contact with the touch sensor at one or more locations. The output of the touch sensor indicates the intensity or pressure with which contact is made at different locations on the touch sensor. Typically the output of the touch sensor can be considered an image, i.e., two-dimensional data for which the magnitude of a pixel represents intensity or pressure at a location on the sensor, typically specified in x,y coordinates. This image is processed to identify the locations that were touched on the sensor, called “contacts.” Contacts are identified by locating regions in which the average pixel intensity is above a threshold. The x,y location of a contact generally is determined by the center of mass of this region.

Information about contacts on a touch sensor, such as their positions and motion, generally is used to recognize a gesture being performed by the user. Information about gestures is in turn provided as user input to other applications on a computer, typically indicating commands input by the user.

Some of the challenges in processing information about contacts include disambiguating multiple contacts from single contacts, and disambiguating intentional contact motion from incidental contact motion. If contacts and contact motion are not disambiguated well, gestures would be improperly processed and unintended application behavior would result.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Touch sensor data includes a plurality of frames sampled from a touch sensor over time. Spatial and temporal features of the touch sensor data from a plurality of frames, and contacts and attributes of the contacts in previous frames, are processed to identify contacts and attributes of the contacts in a current frame. For example, the touch sensor data can be processed to identify connected components in a frame, which in turn are processed to identify contacts corresponding to the connected components. A likelihood model can be used to determine the correspondence between components and contacts being tracked from frame to frame. Characteristics of the contacts are processed to determine attributes of the contacts. Attributes of the contacts can include, whether the contact is reliable, shrinking, moving, or related to a fingertip touch. The characteristics of contacts can include information about the shape and rate of change of the contact, including but not limited to a sum of its pixels, its shape, size and orientation, motion, average intensities and aspect ratio.

Accordingly, in various aspects the subject matter can be embodied in a computer-implemented process, an article of manufacture and/or a computing machine. Touch sensor data from a touch sensor is received into memory, wherein the touch sensor data comprises a plurality of frames sampled from the touch sensor over time. Using a processing device, spatial and temporal features of the touch sensor data from a plurality of frames, and contacts and attributes of the contacts in previous frames, are processed to identify contacts and attributes of the contacts in a current frame. In turn, information about the identified contacts and the attributes of the contacts are provided to an application.

For example, one or more connected components can be identified in a frame of the touch sensor data. The components are processed to identify contacts corresponding to the components. Characteristics of the contacts, such as shape information and rate of change, are processed to determine attributes of the contacts identified in the frame.

In some embodiments, the processing the connected components includes applying a velocity of a contact in a previous frame to the position of the contact in the previous frame to provide a likely position of the contact in the frame. The likely position of the contact in the frame is compared with positions of connected components in the frame.

A split labeling of the components can be generated. Contacts can be associated with components using the split labeling. The split labeling can involve splitting a component into two or more components if the component is larger than a contact is expected to be. Also, if two or more contacts are identified as corresponding to a component, then a likelihood model for each contact can be applied to the component. The contact with a highest likelihood as the contact corresponding to the component is selected. The likelihood model can be a Guassian model centered on a likely position of the contact in the frame according to a velocity and position of the contact in a previous frame.

In some embodiments, the characteristics of a contact include a rate of change. For example, if a pixel sum for a contact has not changed by more than a threshold since a last frame, and the pixel sum is greater than a minimum pixel sum, then the contact is marked as reliable. In other embodiments, the characteristics include a change in the contact size. For example, if all pixels in a contact have a pixel value less than a corresponding pixel value of the contact from a previous frame, then the contact is marked as shrinking. If a contact is marked as shrinking then a position of the contact can be set to a position of the contact from a previous frame.

In the following description, reference is made to the accompanying drawings which form a part of this disclosure, and in which are shown, by way of illustration, specific example implementations. It is understood that other implementations may be made without departing from the scope of the disclosure.

### DESCRIPTION OF THE DRAWINGS

FIG. 1 is a block diagram of an example operating environment in which a multi-touch device can be used.

FIG. 2 illustrates an example data structure for a contact list.

FIG. 3 illustrates example images of sensor data from a touch sensor.

FIG. 4 is a data flow diagram of an example implementation of a contact processing module.

FIG. 5 is a flow chart describing an example implementation of connected component analysis.

FIG. 6 is a flow chart describing an example implementation of split labeling.

FIG. 7 is a flow chart describing an example implementation of contact correspondence analysis.

FIG. 8 is a block diagram of an example computing machine in which such a system can be implemented.

### DETAILED DESRIPTION

The following section provides an example operating environment in which such a multi-touch pointing device can be used.

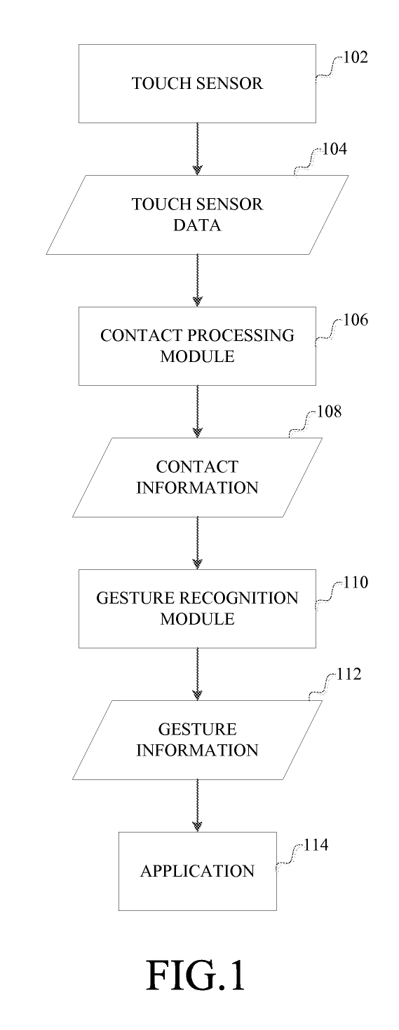

Referring to FIG. 1, an application 114 running on a computer is responsive to user inputs from a multi-touch device 102 with a touch sensor. The device 102 provides touch sensor data 104 to the computer. The touch sensor data is a two-dimensional array of values indicative of the intensity or pressure of contact at a number of points on a grid, which is sampled over time to produce a sequence of frames. The sensor may be capacitive, resistive or optical. The device 102 can also provide additional data from other sensors, such as position data, button data, and the like. The computer includes a contact processing module 106 that processes data from input devices on the computer. Contact processing module 106 can be implemented within a dynamically-linked library for the device 102 running as a user-level process on the computer. In one implementation in which the device 102 is a universal serial bus (USB) device of the human interface device (HID) class, this library receives data provided by a driver for that class of device. Other architectural implementations are possible, and the invention is not limited to a particular architecture.

The contact processing module 106 receives the touch sensor data 104 from one sample time from the device 102 and provides contact information 108, indicative of what the computer determines are contacts on the touch sensor, and attributes of such contacts. The contact information 108 is based, at least on part, on disambiguating contacts from each other, tracking contact motion, and deriving attributes of the contacts using spatial and temporal features of the touch sensor data from a plurality of frames, and contacts and attributes of the contacts in previous frames. Such features can include characteristics of the contact shape and rate of change of this shape and other attributes. The contact information includes information about contacts detected at a given point in time, but also can include contact information from one or more prior points in time. A contact can be characterized by an identifier and by a location, such as an x/y coordinate, and other information, such as a bounding box, pixel weight, pixel count or other characteristic feature of the contact.

A gesture recognition module 110 generally takes the contact information 108 as an input and provides, as its output, gesture information 112. This information could include an indication of a kind of gesture that was performed by the user, and other related information. The gesture information 112 is provided to one or more applications 114. Gestures typically indicate commands or other input from the user to control the behavior of an application 114. The invention is not limited to any specific implementation of or use of gesture recognition.

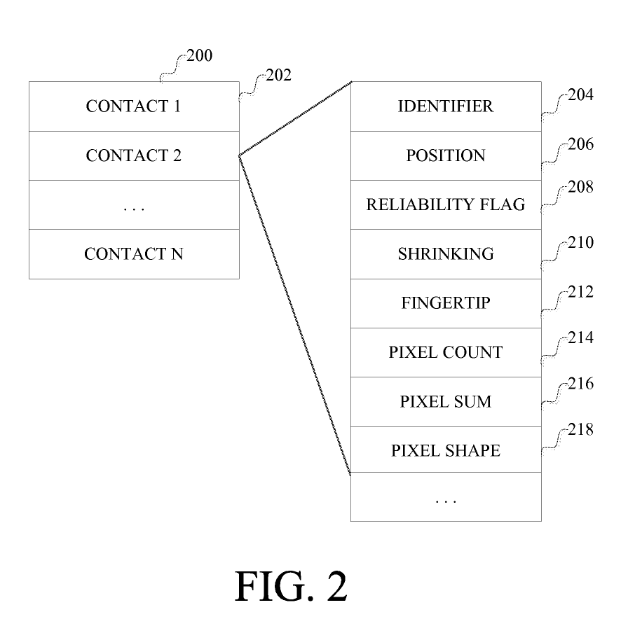

Given this context, an example implementation of the contact processing module 106 will now be described in more detail in connection with FIGS. 2-7.

The contact processing module, in one implementation, generates information about the contacts and attributes of the contacts, such as a contact list for each frame. The contact list is a list of the contacts identified in the sensor data, with each contact having an identifier and several attributes. In one implementation, a contact is intended to mean a point at which a fingertip is in contact with the touch sensor. An example data structure for this information is illustrated in FIG. 2. A contact list 200 includes a list of contacts 202. The data structure for a contact includes data representing an identifier 204 for the contact and a position 206 for the contact, which can be an x,y coordinate for the center of mass of the contact. Additional attributes could include a reliability flag 208, indicating whether the contact has been recognized by the computer to be sufficiently reliable indicator of a contact. A shrinking flag 210 indicates whether the contact area is shrinking. A fingertip flag 212 indicates whether the contact is likely to be a contact from a fingertip. Attributes of the contact also could include a pixel count 214, pixel sum 216 and pixel shape 218. Other attributes (not shown in FIG. 2) include a number of times the contact has been seen, a velocity of the contact, and a time stamp (to allow velocity to be computed from a subsequent position of the contact at a subsequent time).

There are several challenges in identifying fingertip contacts in the sensor data.

First, users are not always conscious of how they are holding and touching an input device, as will be described below. In particular, a user does not always try to contact the touch sensor in a way that provides easily identifiable fingertip contacts. Also, the user can change posture, or the grip with which the input device is held. Motion of the finger, due to touching or lifting off fingers from the sensor, rolling a finger, re-gripping, or changing pressure of a touch, also can affect the sensor data.

Second, sensor data can be noisy, due to transmission of the sensor data from the input device to a computer. Interference with this transmission can create errors or noise in the sensor data.

Third, the pixel intensities in the sensor data are not absolute. Instead, the intensity seen for each pixel can depend upon how the input device is held, the location of the pixel within the sensor (not all pixels have equal response), and the number and location of the pixels contacted.

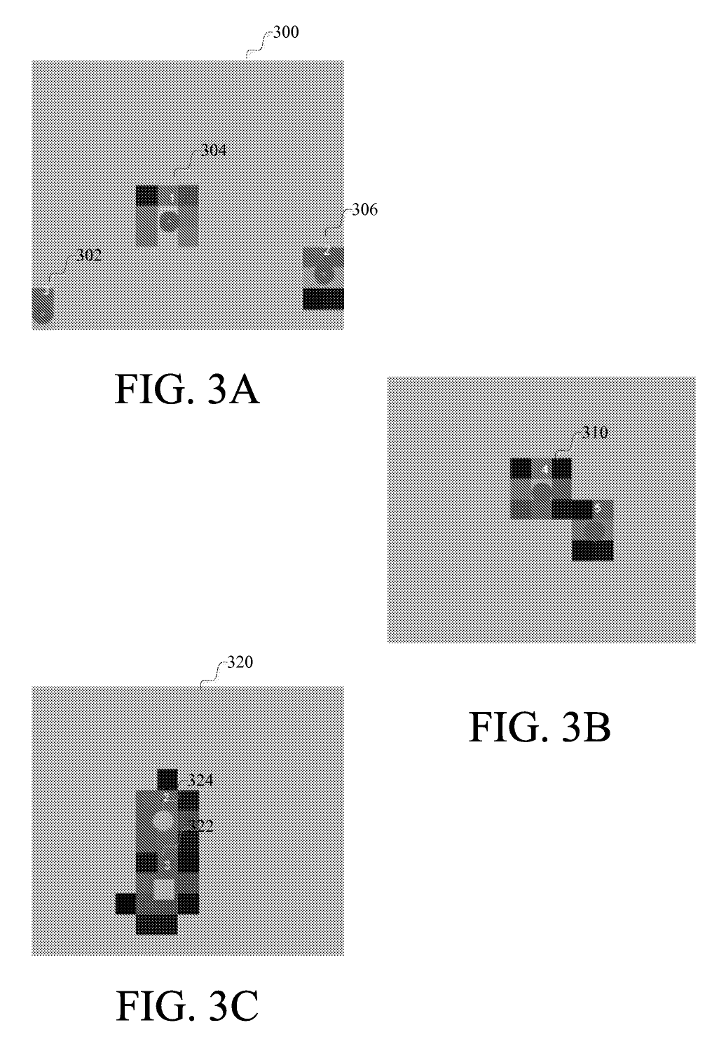

Some example problems to be solved are shown in the images of FIGS. 3A through 3C. FIG. 3A illustrates a sensor image 300 arising from distinct fingertip contacts. The sensor image includes a set of discrete connected components. Herein a connected component in a sensor image is a collection of pixels that are ‘next to’ each other. Whether components are connected can be determined, for example, using a standard image processing technique called ‘connected component analysis.’ For example, there are three connected components 302, 304 and 306, each corresponding to a fingertip contact. The diagram indicates a center of mass of each contact with a circle. In FIG. 3B, the fingertip contacts are close enough that they are represented by a single connected component 310. This case is referred to herein as a “merged contact” since the pixels activated by the two touches result are merged into a single connected component. In some cases, more than two fingers can result in a sensor image with a single connected component, with three or more merged contacts. In some cases, the sensor image results from other parts of the hand being in contact with the touch sensor. For example, in FIG. 3C, the sensor image 320 results from a single finger touching the sensor, but laying down instead of just the fingertip touching. If a center of mass calculation were applied to the connected components resulting from this image, the position would be in the middle of the finger (at 322) instead of the middle of the fingertip (at 324). In other cases, the entire hand could be resting on the sensor.

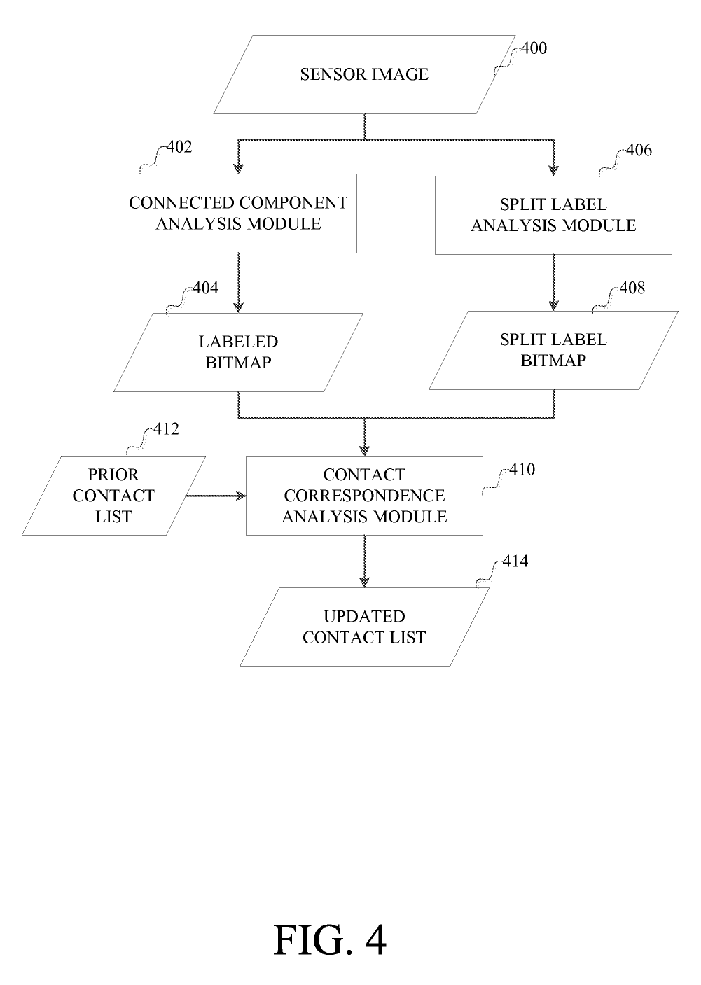

Referring now to FIG. 4, an example implementation of how such images can be processed to discriminate among fingertip contacts to provide a contact list (such as in FIG. 2), using spatial and temporal features of the touch sensor data from a plurality of frames, and contacts and attributes of the contacts in previous frames, will now be described in more detail.

The sensor image 400 is input to a connected component analysis module 402 for which the output is a labeled bitmap 404. The label bitmap has the same dimensions as the sensor image, with all values initially set to zero. Zero is a reserved value indicating that the pixel does not belong to any label. Otherwise, the value of the pixel in the label bitmap indicates the component of which the pixel is a member. Thus, the component to which a pixel in the sensor image belongs is specified by the value stored in the corresponding pixel in the label bitmap. An implementation for generating the label bitmap is described in more detail below.

A second labeling also is performed, called split labeling, by the split labeling analysis module 406. The process of split labeling is similar to the processing the label bitmap, except that all values less than a threshold are considered equal to zero, and additional post-processing steps are performed. Split labeling helps to identify where a single connected component includes merged contacts, or contacts that are not fingertips. The output of module 406 is a split label bitmap 408. An implementation for split labeling is described in more detail below.

The label bitmap 404 and split label bitmap 408 are input to a contact correspondence analysis module 410. Any prior contact list 412 (from one or more previous frames) also is used by module 410. The contact correspondence analysis module determines which contact in the current sensor image most likely corresponds with each contact in the contact list from the prior sample time. Contacts are deleted and/or added to the contact list for the current sample time as appropriate. Module 410 also processes the sensor image to evaluate and set the various flags and attributes for each contact. The output of module 410 is a contact list 414 for the current frame, which becomes the prior contact list 412 for the subsequent frame. An implementation for module 410 is described in more detail below.

The two contact lists 412 and 414, one for the current sample time, the other for the previous frame, are then made available to an application, such as an application that performs gesture recognition.

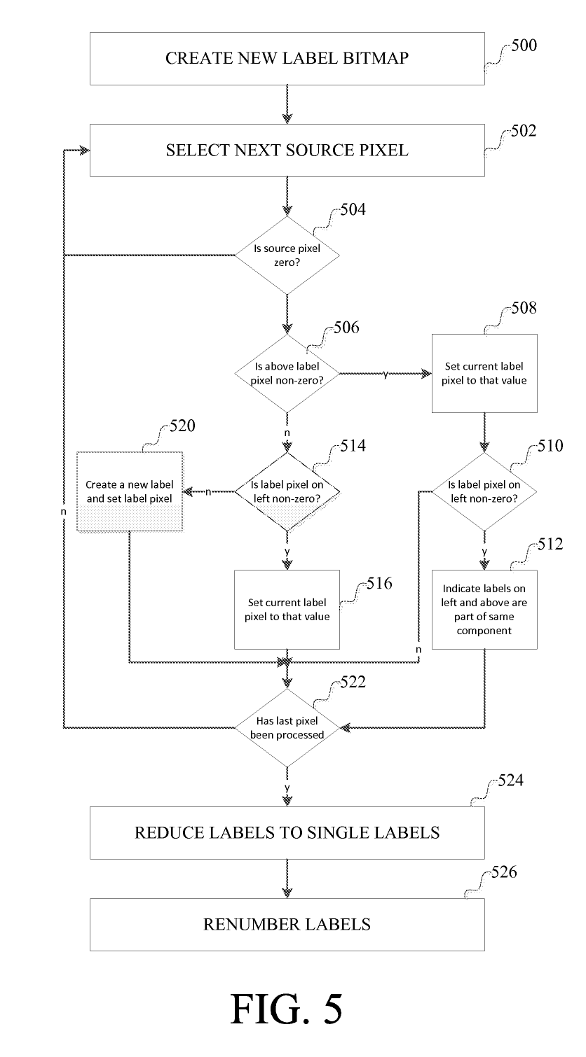

An example implementation of the connected component analysis module 402 will now be described in connection with the flowchart of FIG. 5.

First a new label bitmap is created 500 and initialized. The bitmap is traversed from top to bottom, left to right and is the same size as the sensor data. The process begins by selecting 502 the next source pixel from the sensor data. For each pixel in the label bitmap, if the source pixel in the same position in the sensor data is zero, as determined at 504, continue to the next pixel as indicated at 502. Otherwise, the pixel is processed by analyzing several conditions. If the label pixel above the current pixel is non-zero, as determined at 506, then the current label pixel is set 508 to that value. If the label pixel to the left is non-zero and the label pixel above is non-zero as determined at 510, then indicate 512 that the labels are part of the same component. If the label pixel to the left is non-zero and the label pixel above is zero as determined at 514, then set 516 the current label pixel to the value of the pixel to the left. If neither the pixel above nor the pixel to the left are labeled as determined at 518, then create 520 a new label and set the current label to that pixel value. If the last pixel has not yet been processed, as determined at 522, the next pixel is then processed 502. After processing completes, some label pixels may have two or more equivalent labels. The bit map is again traversed row by row and column by column to reduce 524 any label pixel having two or more labels to a single label. The bit map is again traversed so that the labels are renumbered 526 to fill a contiguous range of integers.

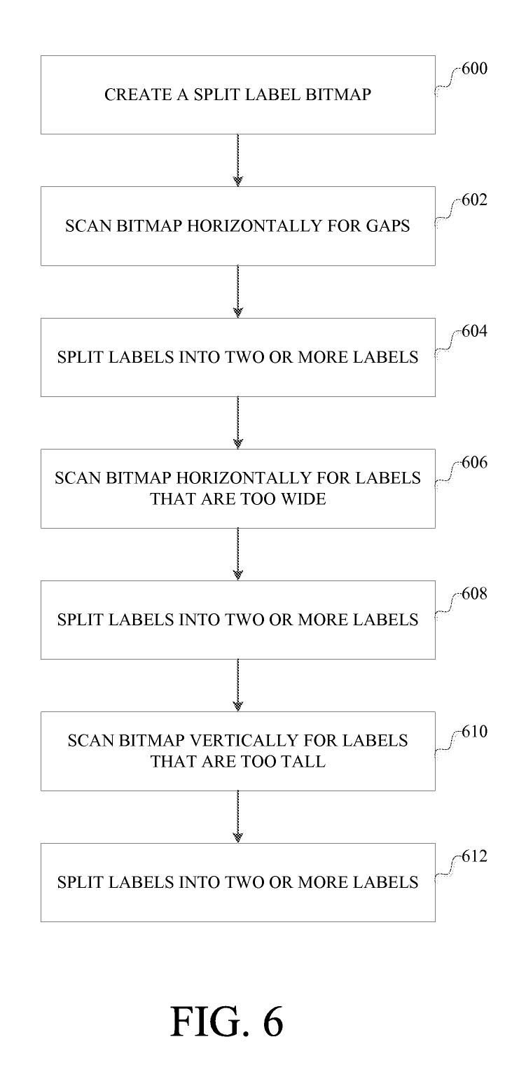

An example implementation of the split labeling module 406 will now be described in connection with the flowchart of FIG. 6. Split labeling is similar to the original labeling of FIG. 5, but with the threshold set to a value above zero (e.g., two in non-scaled sensor bitmap values). The process of FIG. 6 thus includes creating 600 a split label bit map using a non-zero threshold. Next, the label bitmap is scanned 602 horizontally for gaps in single labels using the split label map. These labels are split 604 into two or more labels wherever such gaps are found. The label bitmap also is scanned 606 horizontally for labels that are too wide to be a single fingertip. These labels are split 608 into two or more labels. Also, the label bitmap is scanned 610 vertically for labels that are too tall to be a fingertip. These labels are split 612 into two or more labels.

The resulting label bitmap and the split label bitmap are passed to a contact correspondence analysis module.

The purpose of contact correspondence analysis module 410 is to provide continuity of information about the contacts from one frame to the next. For example, the objective is to provide the same identifier for a contact representing a fingertip from the frame in which the fingertip first touches the sensor, until the frame in which the fingertip is moved from the sensor. However, if a fingertip touches down and then is removed, and then touches down again, its contact will have a new identifier for the second touch. By ensuring that the contact information has continuity, other applications that use contact information can use the identifier to examine the motion of a contact from one sample time to another.

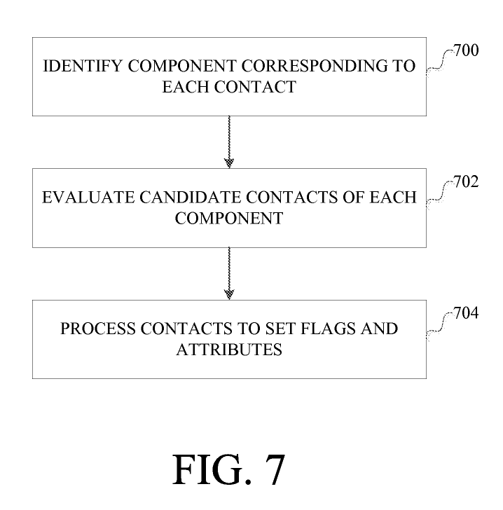

An example implementation of the contact correspondence analysis module 410 will now be described in connection with the flowchart of FIG. 7. First for each existing contact in an existing contact list (e.g., 412), a component in the label bitmap is identified 700 as a most likely place to which that contact has moved, based on the contact's previous position, velocity and time since the last frame. The contact is considered a candidate for that component. For each component, the candidate contacts are then evaluated 702. The objective is to select or create, for each component, a contact from among the candidate contacts, a best fit.

For example, for each component, its number of candidate contacts is compared to the split labeling. If there are more split labels for the component than there are contacts, then additional contacts are created, with each assigned to a split label that does not have a candidate contact. If there is exactly one split label and exactly one candidate contact, then the candidate contact is updated using the component's characteristics, and correspondence for this component is done.

For a split label of a component with multiple candidate contacts, a model is created for each contact to evaluate the likelihood that the contact is the correct corresponding contact for the component. For example, a likelihood can be computed for each contact, and the contact with the highest likelihood can be selected as the contact correspond to the component.

For example, a Gaussian model can be used, centered on the contact's projected position, and using the contact's covariance matrix as a sigma matrix. For each lit pixel in the component, the likelihood of it belonging to each model is computed. If the likelihood is above a threshold, the pixel position, likelihood and weight is stored for the pixel for each model. Then, the center of each model is computed from the pixel positions, likelihoods and weights stored for each model. This center is a new position for the model's associated contact (instead of the original position on which the model was centered). Next, if a model is too close to another model or has too small of a likelihood, then it can be deleted, and the associated contact can be marked as ending.

After processing the candidate contacts, the contacts are further processed 704 to set flags and other attributes. For example, if a contact was previously marked as “ending” then it is deleted. If the contact is not matched with a component, then it is marked as ending. The contact's model attributes are updated including its covariance matrix. The number of times the contact has been seen, and other attributes (e.g., velocity, time stamp), also can be updated. If the contact was just created for this frame, then a “starting” flag can be set. If a contact has both starting and ending flags set, it is likely an error and can be deleted.

Other analyses using spatial features, such as shape information, about a contact can be performed to determine other attributes of the contact. For example the shape information of the contact, and how it is changing over time, can be used to determine whether the contact is stable, moving, lifting, touching, increasing (getting larger), decreasing (shrinking) and the like. The shape information can include: absolute size information, such as area or circumference or number of pixels; or crude shape information such as a bounding box, length and width of a convex hull around the contact, or aspect ratio; or edge information, such as line segments that form the edge around a contact; or model information describing a model fit to the data for the contact. Comparative information can be used, such as how the size and shape of a contact are compared to other contacts, or with information about the same contact from different points in time.

Information based on expected handling by a user also can be used. For example, long contacts typically correspond to fingers. Also, during typical use, a vertical component with several contacts likely has all contacts corresponding to a single finger.

Pixel information, such as grey level information, pixel sums, pixel counts and histograms, and rates of change of this information, also could be used to assist in defining attributes of a contact or disambiguating contacts.

The following are some specific examples of determining attributes from this shape information, including identifying whether a contact can be a fingertip, is reliable, or is shrinking.

An example way to determine whether a contact is likely a fingertip is the following. If, given a contact, there is no other contact in the sensor data with a lower Y value within a certain distance (e.g., a distance representative of a normalized contact width), then it is likely the top most contact, which corresponds to a possible fingertip. Thus, such a contact can be marked to indicate that it can be a fingertip.

An example way to determine whether a contact can be marked as reliable is to analyze its rate of change over time. If the rate of change is less than a threshold, then the contact can be marked as reliable. Any of a variety of characteristics of a contact, such as its shape or its pixel data, can be used. For example, the rate of change of the sum of pixels over time can be analyzed. An example implementation of this is the following. If its pixel sum has not changed by more than a first threshold since the last frame, and its pixel sum is greater than a minimum pixel sum. The minimum pixel sum is a threshold indicating a minimum pixel sum for a contact to be considered reliable. However, if the contact is part of a tall, skinny component, e.g., determined by thresholds applied to the component dimensions, the flag indicating that it is reliable can be cleared. Whether a contact is reliable can be used by a gesture recognition engine as a factor to consider before determining whether a gesture is recognized from that contact. Also, other information about the contact is sometimes smoothed over several frames, such as its position. Such smoothing operations could be suspended when a contact is indicated as unreliable.

An example way to determine whether a contact is shrinking involves analyzing the rate of change of its shape or boundary or pixel content. Any of a variety of measures of the shape, and its rate of change, can determine if the contact is shrinking (or growing). One implementation for determining if a contact is shrinking is the following. If the contact has a 1-1 relationship with a component, and all pixels in that contact are less than their value from the previous frame, the contact can be marked as shrinking. The number of frames it has been marked as shrinking also can be tracked. If this number is above a threshold, and if there are pixels growing, but the number of such pixels is below a threshold, then the frame can remain marked as shrinking, but the number of frames can be reset to zero.

If a contact is marked as shrinking, its position is replaced with the position from the previous frame. Replacing the values in this way reduces the likelihood that a contact will be seen as moving while a finger tip is being removed from the sensor.

The foregoing are merely examples of the kinds of spatial and temporal features in the touch sensor data and contact information that can be processed to define contacts and their attributes. A variety of other kinds of processing also can be performed to define other attributes of contacts.

After this processing, a list of zero or more contacts and their attributes, such as whether it is reliable, starting, ending, shrinking, or can be a fingertip, is available for use by applications, such as a gesture recognition engine that identifies gestures made through the touch sensor.

Having now described an example implementation, a computing environment in which such a system is designed to operate will now be described. The following description is intended to provide a brief, general description of a suitable computing environment in which this system can be implemented. The system can be implemented with numerous general purpose or special purpose computing hardware configurations. Examples of well known computing devices that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

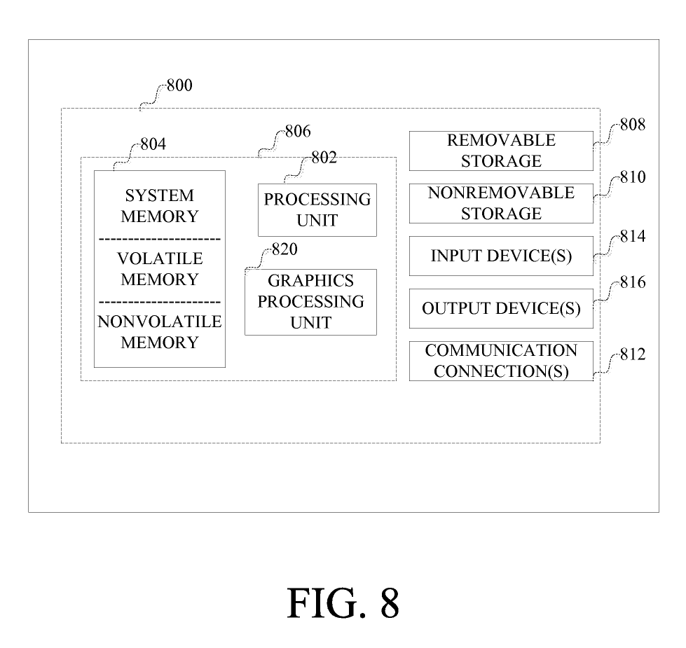

FIG. 8 illustrates an example of a suitable computing system environment. The computing system environment is only one example of a suitable computing environment and is not intended to suggest any limitation as to the scope of use or functionality of such a computing environment. Neither should the computing environment be interpreted as having any dependency or requirement relating to any one or combination of components illustrated in the example operating environment.

With reference to FIG. 8, an example computing environment includes a computing machine, such as computing machine 800. In its most basic configuration, computing machine 800 typically includes at least one processing unit 802 and memory 804. The computing device may include multiple processing units and/or additional co-processing units such as graphics processing unit 820. Depending on the exact configuration and type of computing device, memory 804 may be volatile (such as RAM), non-volatile (such as ROM, flash memory, etc.) or some combination of the two. This most basic configuration is illustrated in FIG. 8 by dashed line 806. Additionally, computing machine 800 may also have additional features/functionality. For example, computing machine 800 may also include additional storage (removable and/or non-removable) including, but not limited to, magnetic or optical disks or tape. Such additional storage is illustrated in FIG. 8 by removable storage 808 and non-removable storage 810. Computer storage media includes volatile and nonvolatile, removable and non-removable media implemented in any method or technology for storage of information such as computer program instructions, data structures, program modules or other data. Memory 804, removable storage 808 and non-removable storage 810 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing machine 800. Any such computer storage media may be part of computing machine 800.

Computing machine 800 may also contain communications connection(s) 812 that allow the device to communicate with other devices. Communications connection(s) 812 is an example of communication media. Communication media typically carries computer program instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media.

Computing machine 800 may have various input device(s) 814 such as a display, a keyboard, mouse, pen, camera, touch input device, and so on. Output device(s) 816 such as speakers, a printer, and so on may also be included. All of these devices are well known in the art and need not be discussed at length here.

The system may be implemented in the general context of software, including computer-executable instructions and/or computer-interpreted instructions, such as program modules, being processed by a computing machine. Generally, program modules include routines, programs, objects, components, data structures, and so on, that, when processed by a processing unit, instruct the processing unit to perform particular tasks or implement particular abstract data types. This system may be practiced in distributed computing environments where tasks are performed by remote processing devices that are linked through a communications network. In a distributed computing environment, program modules may be located in both local and remote computer storage media including memory storage devices.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process comprising:
receiving touch sensor data from a touch sensor into memory, wherein the touch sensor data comprises a plurality of frames sampled from the touch sensor over time;
processing spatial and temporal features of the touch sensor data from a plurality of frames, and contacts and attributes of the contacts in previous frames, to identify contacts and attributes of the contacts in a current frame; and
providing information about the identified contacts in the frame and the attributes of the contacts to an application.

2. The computer-implemented process of claim 1, wherein processing spatial and temporal features comprises:
identifying one or more connected components in a frame of the touch sensor data;
processing the connected components to identify contacts corresponding to the components;
processing characteristics of the contacts to determine attributes of the contacts in the frame.

3. The computer implemented process of claim 2, wherein processing the connected components includes applying a velocity of a contact in a previous frame to the position of the contact in the previous frame to provide a likely position of the contact in the frame, and comparing the likely position of the contact in the frame with positions of connected components in the frame.

4. The computer-implemented process of claim 2, wherein processing the components comprises generating a split labeling of the components, and associating contacts with components using the split labeling.

5. The computer-implemented process of claim 4, wherein generating the split labeling includes splitting a component into two or more components if the component is larger than a contact is expected to be.

6. The computer-implemented process of claim 2, wherein processing the components comprises:
if two or more contacts are identified as corresponding to a component, then applying a likelihood model for each contact to the component, and selecting the contact with a highest likelihood as the contact corresponding to the component.

7. The computer-implemented process of claim 6, wherein the likelihood model is a Gaussian model centered on a likely position of the contact in the frame according to a velocity and position of the contact in a previous frame.

8. The computer-implemented process of claim 2, wherein the characteristics of a contact include a rate of change of the contact, and if the rate of change of the contact is less than a threshold, then the contact is marked as reliable.

9. The computer-implemented process of claim 2, wherein the characteristics of a contact include a change in the contact, and if the change in the contact indicates that the contact is smaller than the corresponding contact from a previous frame, then the contact is marked as shrinking; and if a contact is marked as shrinking then a position of the contact is set to a position of the contact from a previous frame.

10. The computer-implemented process of claim 2, wherein if a contact is determined to be a top most contact in a set of vertically aligned contacts, then the contact is marked to indicate that it can be a fingertip.

11. A computing machine comprising:
an input device having a touch sensor and providing touch sensor data comprising a plurality of frames sampled from the touch sensor over time;
a memory for storing touch sensor data of a least one frame;
a processing device having inputs for receiving touch sensor data from the memory and being configured to:
process spatial and temporal features of the touch sensor data from a plurality of frames, and contacts and attributes of the contacts in previous frames, to identify contacts and attributes of the contacts in a current frame; and
provide information about the identified contacts and the attributes of the contacts to an application.

12. The computing machine of claim 11, wherein, to process spatial and temporal features, the processing device is configured to:
identify one or more connected components in a frame of the touch sensor data;
process the connected components to identify contacts corresponding to the connected components;
processing characteristics of the contacts to determine attributes of the identified contacts in the frame; and

13. The computing machine of claim 12, wherein to process the connected components, the processing device is configured to apply a velocity of a contact in a previous frame to the position of the contact to provide a likely position of the contact in the frame, and compare the likely position of the contact in the frame with connected components in the frame.

14. The computing machine of claim 12, wherein to process the connected components, the processing device is configured to generate a split labeling of the components, and associate contacts with components using the split labeling.

15. The computing machine of claim 14, wherein to generate the split labeling, the processing device is further configured to split a component into two or more components if the component is larger than a contact is expected to be.

16. The computing machine of claim 12, wherein to process the components the processing device is further configured to, if two or more contacts are identified as corresponding to a component, apply a likelihood model for each contact to the component, and select the contact with a highest likelihood as the contact corresponding to the component.

17. The computing machine of claim 16, wherein the likelihood model is a Gaussian model centered on a likely position of the contact in the frame according to a velocity and position of the contact in a previous frame.

18. The computing machine of claim 12, wherein the characteristics of a contact include a rate of change of a contact, and if the rate of change of the contact since a last frame is less than a threshold, then the contact is marked as reliable.

19. The computing machine of claim 12, wherein the characteristics of a contact include a change in the contact, and if the change in the contact indicates the contact is smaller than a corresponding contact from a previous frame, then the contact is marked as shrinking; and if a contact is marked as shrinking then a position of the contact is set to a position of the contact from a previous frame.

20. The computing machine of claim 12, wherein if a contact is determined to be a top most contact in a set of vertically aligned contacts, then the contact is marked to indicate that it can be a fingertip.
